(19) United States
(12) Patent Application Publication
(10) Pub. No.: US 2005/0173259 A1
(43) Pub. Date: Aug. 11, 2005

(54) Endpoint system for electro-chemical mechanical polishing

(75) Inventors: Rashid Mavliev, Campbell, CA (US); Boguslaw A. Swedek, Cupertino, CA (US); Andreas Norbert Wiswesser, Freiberg (DE); Manoocher Birang, Los Gatos, CA (US)

Correspondence Address: PATENT COUNSEL;APPLIED MATERIALS, INC., Legal Affairs Department, P.O.Box 450A, Santa Clara, CA, 95052, US

(73) Assignee: Applied Materials, Inc.

(21) Appl. No.: 10/773,868

(22) Filed: Feb. 6, 2004

(51) Int. Cl. B24B 49/00; B23H 7/00; C25B 9/04; B23H 11/00

(52) U.S. Cl. 205/645; 451/5; 205/672; 451/526

(57) ABSTRACT

An electrochemical mechanical polishing apparatus has a rotatable platen to support a polishing pad, a carrier head to hold a substrate against the polishing pad, and multiple sensors, e.g., optical sensors or eddy current sensors, spaced at different angular positions about the axis of rotation of the platen. Each of the sensors can be substantially identical. A processor receives the signal from each of the sensors to determines a polishing endpoint.

### BACKGROUND

The present invention relates to methods and apparatus for monitoring a metal layer on a substrate during electro-chemical mechanical polishing.

An integrated circuit is typically formed on a substrate by the sequential deposition of conductive, semiconductive or insulative layers on a silicon wafer. One fabrication step involves depositing a filler layer over a non-planar surface, and planarizing the filler layer until the non-planar surface is exposed. For example, a conductive filler layer, such as copper, can be deposited on a patterned insulative layer to fill the trenches or holes in the insulative layer. The filler layer is then polished until the raised pattern of the insulative layer is exposed. After planarization, the portions of the conductive layer, remaining between the raised pattern of the insulative layer form vias, plugs and lines that provide conductive paths between thin film circuits on the substrate. In addition, planarization is needed to planarize the substrate surface for photolithography.

Chemical mechanical polishing (CMP) is one accepted method of planarization. This planarization method typically requires that the substrate be mounted on a carrier or polishing head. The exposed surface of the substrate is placed against a rotating polishing disk pad or belt pad. The polishing pad can be either a “standard” pad or a fixed-abrasive pad. A standard pad has a durable roughened surface, whereas a fixed-abrasive pad has abrasive particles held in a containment medium. The carrier head provides a controllable load on the substrate to push it against the polishing pad. A polishing liquid, including at least one chemically-reactive agent, is supplied to the surface of the polishing pad. The polishing liquid can optionally include abrasive particles, e.g., if a standard pad is used.

A variation of CMP, which is particularly useful for copper polishing, is electrochemical mechanical polishing (ECMP). In ECMP techniques, conductive material is removed from the substrate surface by electrochemical dissolution while concurrently polishing the substrate, typically with reduced mechanical abrasion as compared to conventional CMP processes. The electrochemical dissolution is performed by applying a bias between a cathode and the substrate surface and thus remove conductive material from the substrate surface into a surrounding electrolyte.

One problem in CMP and ECMP is determining whether the polishing process is complete, i.e., whether a substrate layer has been planarized to a desired flatness or thickness, or when a desired amount of material has been removed. Overpolishing (removing too much) of a conductive layer or film leads to increased circuit resistance. On the other hand, underpolishing (removing too little) of a conductive layer leads to electrical shorting. Variations in the initial thickness of the substrate layer, the slurry composition, the polishing pad condition, the relative speed between the polishing pad and the substrate, and the load on the substrate can cause variations in the material removal rate. These variations cause variations in the time needed to reach the polishing endpoint. Therefore, the polishing endpoint cannot be determined merely as a function of polishing time.

One way to determine the polishing endpoint is to remove the substrate from the polishing surface and examine it. For example, the substrate can be transferred to a metrology station where the thickness of a substrate layer is measured, e.g., with a profilometer or a resistivity measurement. If the desired specifications are not met, the substrate is reloaded into the CMP apparatus for further processing. This is a time-consuming procedure that reduces the throughput of the CMP apparatus. Alternatively, the examination might reveal that an excessive amount of material has been removed, rendering the substrate unusable.

More recently, in-situ monitoring of the substrate has been performed, e.g., with optical or capacitance sensors, in order to detect the polishing endpoint. Other proposed endpoint detection techniques have involved measurements of friction, motor current, slurry chemistry, acoustics and conductivity. One detection technique that has been considered is to induce an eddy current in the metal layer and measure the change in the eddy current as the metal layer is removed.

Another reoccurring problem in CMP is dishing of the substrate surface when polishing a filler layer to expose an underlying layer. Specifically, once the underlying layer is exposed, the portion of the filler layer located between the raised areas of the patterned underlying layer can be overpolished, creating concave depressions in the substrate surface. Dishing can render the substrate unsuitable for integrated circuit fabrication, thereby lowering process yield.

### SUMMARY

In one aspect, the invention is directly to a chemical mechanical polishing apparatus. The apparatus includes a platen to support a polishing pad, a carrier head to hold a substrate against the polishing pad, a plurality of substrate monitoring sensors secured to the platen, and a processor to receive the signal from each of the plurality of sensors and determine a polishing endpoint. The platen is rotatable about an axis, the sensors are spaced at different angular positions about the axis, each of the sensors is substantially identical, and each of the sensors is configured to monitor a characteristics of the substrate while that sensor is positioned adjacent the substrate and to generate a signal based thereon.

Implementations of the invention may include one or more of the following features. The sensors may be spaced at substantially equal radial distances from the axis, or at different radial distances from the axis. The sensors may be spaced at substantially equal angular intervals around the axis. Each of the sensors may be a non-contact sensor. Each of the sensors may be an eddy current sensor including a coil to generate an oscillating magnetic field to induce eddy currents in a metal layer in the substrate while the sensor is positioned adjacent the substrate. The eddy current sensor may include a core, and the coil may be wrapped around a portion of the core. Each of the sensors may be an optical sensor that includes a light source to generate a light beam and direct the light beam to impinge the substrate and a detector to receive reflections of the light beam from the substrate while the sensor is positioned adjacent the substrate. A polishing pad may be located on the platen, and the polishing pad may include a plurality of fluid-impermeable windows, and each sensor may directs the light beam through an associated window and each detector receives reflections through the associated window. A housing may hold the sensor, and the housing may positioned at least partially in a cavity in the platen. The housing may extend above a top surface of the platen. A first electrode may contact a polishing electrolyte on the polishing pad, a second electrode may contact the substrate, and a voltage source may apply a voltage between the first electrode and the second electrode. Switching circuitry may be located in the platen to combine the signal from each of the plurality of sensors and generate a common output signal. A motor may rotate the platen, a controller may be coupled to the motor, and the controller may be configured to cause the motor to rotate the platen at a rotation rate of about 25 revolutions per minute or less, e.g., about five to seven revolutions per minute.

In another aspect, the invention is directed to an electrochemical mechanical polishing apparatus that includes a rotatable platen to support a polishing pad, a weir to contain an electrolyte on the polishing pad, a carrier head to hold a substrate against the polishing pad, a first electrical contact for connection to a first electrode for contacting the polishing electrolyte on the polishing pad, a second electrical contact for connection to second electrode for contacting the substrate in contact with the polishing pad, a voltage source to apply a voltage between the first electrical contact and the second electrical contact, and an eddy current sensor secured to the platen including a coil to generate a magnetic field to induce eddy currents in a metal layer in the substrate while the sensor is positioned adjacent the substrate.

Implementations of the invention may include one or more of the following features. A housing may hold the eddy current sensor, and the housing may be positioned at least partially in a cavity in the platen. The housing may extend above a top surface of the platen, and may includes a projection that extends above the top surface of the platen. The eddy current sensor may include a core, and at least a portion of the core may be positioned in the projection. A polishing pad may be positioned on the platen, and the polishing pad may include an aperture aligned with the housing. The housing may extend partially into the aperture. A fluid seal, e.g., an o-ring, may be positioned between the platen and the housing. The second electrode may be provided by a polishing layer in the polishing pad, and the aperture may be formed through the second electrode. The housing may extend at least partially through the aperture in the second electrode. An aperture may formed in the first electrode and aligned with the eddy current sensor. The housing may extends at least partially through the aperture in the first electrode. The first electrode may be positioned between the platen and a non-conductive polishing layer. A plurality of an eddy current sensors may be secured to the platen, the sensors may be spaced at substantially equal radial distances from the axis but at different angular positions about the axis, each of the sensors may be substantially identical, and each eddy current sensor may include a coil to generate a magnetic field to induce eddy currents in a metal layer in the substrate while the sensor is positioned adjacent the substrate.

In another aspect, the invention is directed to an electrochemical mechanical polishing apparatus that includes a rotatable platen to support a polishing pad, a weir to contain an electrolyte on the polishing pad, a carrier head to hold a substrate against the polishing pad, a first electrical contact for connection to a first electrode for contacting the polishing electrolyte on the polishing pad, a second electrical contact for connection to second electrode for contacting the substrate in contact with the polishing pad, a voltage source to apply a voltage between the first electrical contact and the second electrical contact, and an optical sensor secured to the platen and including a light source to generate a light beam and to direct the light beam to impinge the substrate and a detector to receive reflections of the light beam from the substrate while the sensor is positioned adjacent the substrate.

Implementations of the invention may include one or more of the following features. The polishing pad may have a polishing layer with a polishing surface, the polishing pad may include at least one of the first electrode and the second electrode, and the polishing pad may include a window aligned with the optical sensor. The window may include an aperture. A transparent sheet may span the aperture. The transparent sheet may span the polishing pad. The polishing pad may include the first electrode as a conductive layer, and a plurality of perforations may be formed through the polishing layer to expose the conductive layer. The transparent sheet may be positioned between the first electrode and the platen. The transparent sheet may be positioned between the polishing layer and the first electrode, and the perforations may be formed through the transparent sheet. The polishing layer may be conductive and may provide the first electrode, and the transparent sheet may be positioned between the polishing layer and the platen. The window may include a solid, transparent element secured and extending through at least a portion of the polishing pad. The polishing pad may include the first electrode as a conductive layer. The first electrode may include an aperture aligned with the solid transparent element. The solid transparent may element extend at least partially through the first electrode. A plurality of optical sensors may secured to the platen, the sensors may be spaced at substantially equal radial distances from the axis but at different angular positions about the axis, each of the sensors may be substantially identical, and each sensor may include a light source to generate a light beam and to direct the light beam to impinge the substrate and a detector to receive reflections of the light beam from the substrate while the sensor is positioned adjacent the substrate.

In another aspect, the invention may be directed to a polishing pad assembly that includes a polishing layer having a polishing surface, an electrode layer, a plurality of perforations through the polishing layer to expose the electrode layer, and a window though the polishing layer and the electrode layer. The window includes a fluid-impermeable element.

Implementations of the invention may include one or more of the following features. The window may include an aperture through the polishing layer and the electrode layer. The fluid-impermeable element may include a transparent sheet spanning the aperture. The transparent sheet may span the polishing pad. The transparent sheet may be positioned on a side of the electrode layer opposite the polishing layer. The transparent sheet may be positioned between the electrode layer and the polishing layer. The perforations may extend through the transparent sheet. A backing layer may be located between the polishing layer and the electrode layer. The transparent sheet may be positioned between the electrode layer and the backing layer. The transparent sheet may be positioned between the backing layer and the polishing layer. The fluid-impermeable element may include a transparent plug extending through at least a portion of at least one of the polishing layer and the electrode layer. The transparent plug may be positioned in the polishing layer. There may be a non-conductive backing layer between the polishing layer and the electrode layer. The polishing layer may be a conductive layer. A top surface of the transparent plug may be flush with the polishing surface.

In another aspect, the invention is directed to a method for electrochemical mechanical polishing of a metal layer on a substrate. The method includes polishing the substrate at a first polishing station with a first polishing surface immersed in an electrolyte at a first polishing rate, monitoring polishing at the first polishing station with an eddy current monitoring system, transferring the substrate to a second polishing station when the eddy current monitoring system indicates that a predetermined thickness of the metal layer remains on the substrate, polishing the substrate at the second polishing station with a second polishing surface immersed in an electrolyte at a second polishing rate that is lower than the first polishing rate, monitoring polishing at the second polishing station with an optical monitoring system, and halting polishing when the optical monitoring system indicates that an underlying layer is at least partially exposed.

Implementations of the invention may include one or more of the following features. The first underlying layer may be a barrier layer. Polishing at the second polishing station may continue until the underlying layer is substantially entirely exposed. The eddy current monitoring system may include two or more eddy current sensors. The eddy current monitoring system may include three eddy current sensors separated with an angular distance of 120 degrees. The eddy current sensors may be placed at a same distance from a center of the first polishing station. Output signals from each eddy current sensor in the eddy current monitoring system may be combined into a single output signal. The optical monitoring system may include two or more optical sensors. The optical monitoring system may include three optical sensors separated with an angular distance of 120 degrees. The optical sensors may be placed at a same distance from a center of the first polishing station. Output signals from each optical sensor in the optical monitoring system may be combined into a single output signal. The substrate may be transferred to a third polishing station and buffing the substrate with a buffing surface.

In another aspect, the invention is directed to a method of electrochemical mechanical polishing a metal layer on a substrate. The method includes polishing the substrate at a first polishing rate in an electrolyte while applying a voltage between the substrate and an electrode in the electrolyte, monitoring polishing with an eddy current monitoring system, reducing the polishing rate when the eddy current monitoring system indicates that a predetermined thickness of the metal layer remains on the substrate, monitoring polishing with an optical monitoring system, and halting polishing when the optical monitoring system indicates that an underlying layer is at least partially exposed.

In another aspect, the invention is directed to a method of electrochemical mechanical polishing. The method includes bringing a substrate into contact with a polishing pad on platen rotatable about an axis, polishing the substrate in an electrolyte while applying a voltage between the substrate and an electrode in the electrolyte, scanning the substrate sequentially with a plurality of substrate monitoring sensors secured to the platen, and determining a polishing endpoint from signals from the plurality of sensors. The sensors are spaced at substantially equal radial distances from the axis but at different angular positions about the axis, each of the sensors is substantially identical, and each of the sensors is configured to monitor a characteristic of the substrate while that sensor is positioned adjacent the substrate and to generate a signal based thereon.

Possible advantages of implementations of the invention can include one or more of the following. The use of multiple sensors may improve accuracy of film thickness measurements and/or reliability of endpoint detection at low platen rotation speeds. Data from the multiple sensors may be combined into a single signal to simplify data storage and polishing process control. Eddy current sensors may be encapsulated in sensor holders and may be positioned close to the substrate surface to improve measurement accuracy. Different types of sensors may be used for bulk removal of copper film and for residue clearing, and each sensor type may be calibrated for the respective operation in which it is used. A transparent film between the pad and platen may prevent fluid from leaking into the sensor without adversely affecting optical signal transmission. The transparent film may also facilitate pad replacement. Polishing may be stopped with high accuracy. Overpolishing and underpolishing may be reduced, as can dishing and erosion, thereby improving yield and throughput.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic top view of an electrochemical mechanical polishing apparatus.

FIG. 2 is a schematic side view, partially cross-sectional (primarily along line A-A of FIG. 4), of an electrochemical mechanical polishing station that includes an eddy current monitoring system.

FIG. 3A is a schematic side view, partially cross-sectional, showing a portion of an electrochemical mechanical polishing system in which a conductive electrode extends through an aperture in the polishing pad.

FIG. 3B is a schematic side view, partially cross-sectional, showing a portion of an electrochemical mechanical polishing system in which a conductive element is embedded in the polishing pad.

FIG. 3C is a schematic side view, partially cross-sectional, showing a portion of an electrochemical mechanical polishing system in which the polishing layer is conductive.

FIG. 4 is a schematic top view of the polishing station of FIG. 2.

FIG. 5 is a schematic side view, partially cross-sectional (primarily along line A-A of FIG. 7), of an electrochemical mechanical polishing station that includes an optical monitoring system.

FIGS. 6A-6E are schematic side-views, partially cross-sectional, showing construction of an optical window through a polishing pad.

FIG. 7 is a schematic top view of the polishing station of FIG. 5.

FIG. 8 is a schematic top view of another implementation of a polishing station that includes multiple sensors.

FIG. 9 is a flowchart illustrating a method of polishing a metal layer.

FIG. 10 is a flowchart illustrating an alternative method of polishing a metal layer.

Like reference symbols in the various drawings indicate like elements.

### DETAILED DESCRIPTION

An electro-chemical mechanical polishing (L-CMP) process and apparatus will be described below. The L-CMP process is similar to the conventional CMP process, but has been designed for copper film polishing at very low down and shear forces, and is therefore suitable for low-k/Cu technologies.

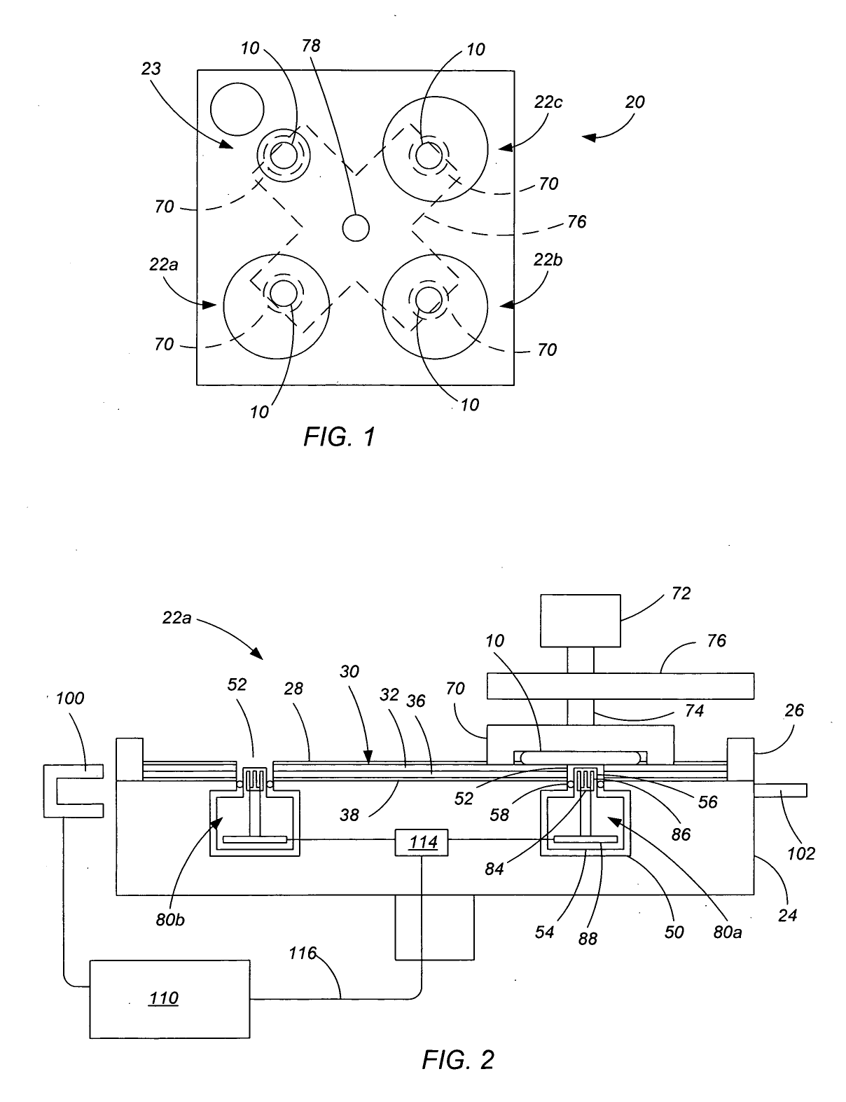

As can be seen in FIG. 1, one or more substrates 10 can be polished by an electro-chemical mechanical (L-CMP) apparatus 20. A description of a similar conventional CMP polishing apparatus can be found in U.S. Pat. No. 5,738,574, the entire disclosure of which is incorporated herein by reference. Two fundamental differences between the L-CMP apparatus 20 and a conventional CMP polishing apparatus are, first, that in the L-CMP polishing process an electrolyte is used on the platen and, second, that an electrical bias is applied to the substrate. In addition, the L-CMP process may be conducted at a lower rotation speed during polishing, both to reduce stress on the substrate and to prevent splashing of the electrolyte.

The L-CMP polishing apparatus 20 includes a series of polishing stations 22a, 22b and 22c, and a transfer station 23. The first station 22a can be used for removal of copper at a high rate, the second polishing station 22b can be used for low-dishing clearing of copper residues, and the third polishing station 22c can be used for removal of any barrier layer.

The transfer station 23 transfers the substrates between the carrier heads and a loading apparatus.

The ECMP apparatus can include a rotatable multi-head carousel 76 (shown in phantom in FIG. 1) that supports four carrier heads 70 (shown in phantom in FIG. 1). The carousel is rotated by a central post 78 by a carousel motor assembly to orbit the carrier head systems and the substrates attached thereto between the polishing stations 22a-c and the transfer station 23. Three of the carrier head systems receive and hold substrates, and polish them by pressing them against the polishing pads. Meanwhile, one of the carrier head systems receives a substrate from and delivers a substrate to the transfer station 23.

Referring to FIG. 2, each carrier head 70 is connected by a carrier drive shaft 74 to a carrier head rotation motor 72 so that each carrier head can independently rotate about its own axis. In addition, each carrier head 70 can independently laterally oscillate in a radial slot formed in a support plate of the carousel 76. A description of a suitable carrier head 70 can be found in U.S. Pat. Nos. 6,422,927 and 6,450,868, and in U.S. patent application Ser. No. 09/712,389, filed Nov. 13, 2000, the entire disclosures of which are incorporated herein by reference.

Each polishing station also includes a rotatable platen 24 on which is placed a polishing pad 30. Each polishing station can also include a pad conditioner apparatus to maintain the condition of the polishing pad so that it will effectively polish substrates. In operation, the platen 24 is rotated about its central axis, and the carrier head 70 is rotated about its central axis and translated laterally across the surface of the polishing pad to provide relative motion between the substrated polishing pad. The edge of the platen 24 has a barrier wall or weir 26 so that a polishing electrolyte 28 can be contained on the polishing pad 30 during polishing. An example of suitable electrolyte for L-CMP polishing is described in U.S. patent application Ser. No. 10/038,066, filed on Jan. 3, 2002, the entirety of which is incorporated by reference.

Electrolyte solutions used for electrochemical processes such as copper plating and/or copper anodic dissolution are available from Shipley Leonel, in Philadelphia, Pa., under the tradename Ultrafill 2000, and from Praxair, in Danbury, Conn., under the tradename EP3.1. Optionally, the polishing electrolyte 28 can include abrasive particles. The polishing electrolyte can be supplied to the surface of the polishing pad 30 through ports in the polishing pad, or through a polishing liquid delivery arm.

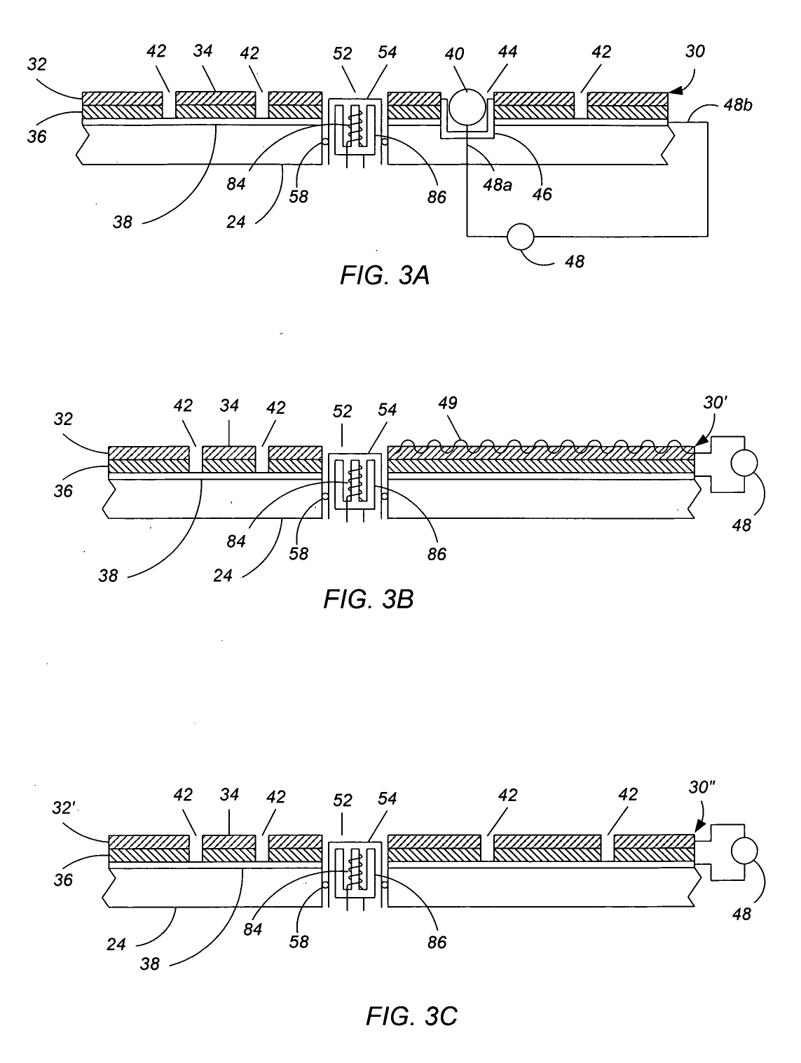

As noted above, the L-CMP apparatus applies an electrical bias to the substrate. A variety of techniques are available to apply this electrical bias. In one implementation, the bias is applied by electrodes that extend through apertures in a non-conductive dielectric polishing layer to contact the substrate. For example, referring to FIG. 3A, the polishing pad assembly 30 includes a non-conductive polishing layer 32 with a polishing surface 34, a non-conductive backing layer 36 that can be softer than the polishing layer 32, and a counter-electrode layer 38 which abuts the surface of platen 24. The polishing layer 32 and the backing layer 36 can be a conventional two-layer polishing pad. For example, the polishing layer 32 can be composed of foamed or cast polyurethane, possibly with fillers, e.g., hollow microspheres, and/or a grooved surface, whereas the backing layer 36 can be composed of compressed felt fibers leached with urethane. Perforations 42 are formed through the polishing layer 32 and the backing layer 36 to expose the counter-electrode layer 38. In addition, one or more apertures 44 can be formed through both the pad layers 32, 36 and the counter-electrode layer 38. The counter-electrode layer 38, backing layer 36 and polishing layer 32 can be assembled as a single unit, e.g., the counter-electrode 38 can be adhesively attached to the backing layer 36, and the resulting polishing pad assembly can then be secured to the platen.

One or more electrodes, which can be rotatable conductive spheres (rollers) 40, fit in the aperture 44 and extend slightly above the polishing surface 34 so as to contact the substrate 10 during polishing. Each conductive roller 40 can be captured by a housing 46. A voltage source 48 can be connected to the conductive rollers 40 and the counter-electrode layer 38 by electrical contacts 48a and 48b (e.g., conductive electrical contacts embedded in a non-conductive platen), respectively, to apply a voltage difference between the rollers 40 and the counter-electrode layer 38. Such a system is described in U.S. patent application Ser. No. 10/445,239, filed May 23, 2003, the entirety of which is incorporated herein by reference.

In another implementation, the bias is applied by electrodes that are embedded in a non-conductive dielectric polishing layer. For example, referring to FIG. 3B, the polishing pad assembly 30′ includes a non-conductive polishing layer 32 with a polishing surface 34, a non-conductive backing layer 36 that can be softer than the polishing layer 32, and a counter-electrode layer 38 which abuts the surface of platen 24. A conductive element 49, such as a metal wire, is embedded in the non-conductive dielectric polishing layer 32 (for simplicity, the conductive element 49 is shown on only half of the polishing pad, but it could extend across the entire polishing pad). At least part of the conductive element 49 projects above the polishing surface 34 in order to contact the substrate during polishing. A voltage difference is applied between the conductive element 49 and the counter-electrode layer 38 by the voltage source 48. Such a polishing pad and the associated polishing system is described in the aforementioned U.S. patent application Ser. No. 10/445,239.

In another implementation, the polishing layer itself is conductive and applies the bias. For example, referring to FIG. 3C, the polishing pad assembly 30″ includes a conductive polishing layer 32′ with a polishing surface 34, a non-conductive backing layer 36, and a counter-electrode layer 38 which abuts the surface of platen 24. The conductive polishing layer 32′ can be formed by dispersing conductive fillers, such as fibers or particles (including conductively coated dielectric fibers and particles) through the polishing pad. The conductive fillers can be carbon-based materials, conductive polymers, or conductive metals, e.g., gold, platinum, tin, or lead. A voltage difference is applied between the conductive polishing layer 32′ and the counter-electrode layer 38 by the voltage source 48. Such a polishing pad and the associated polishing system is described in the aforementioned U.S. patent application Ser. No. 10/445,239.

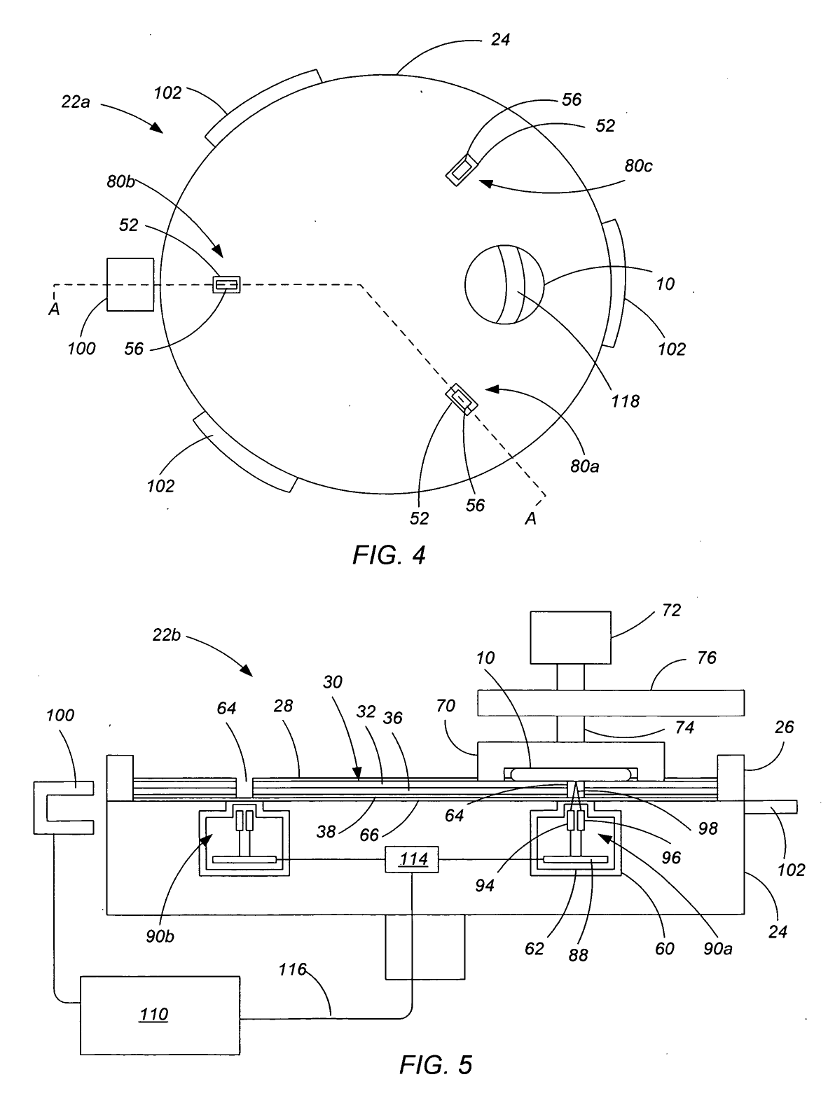

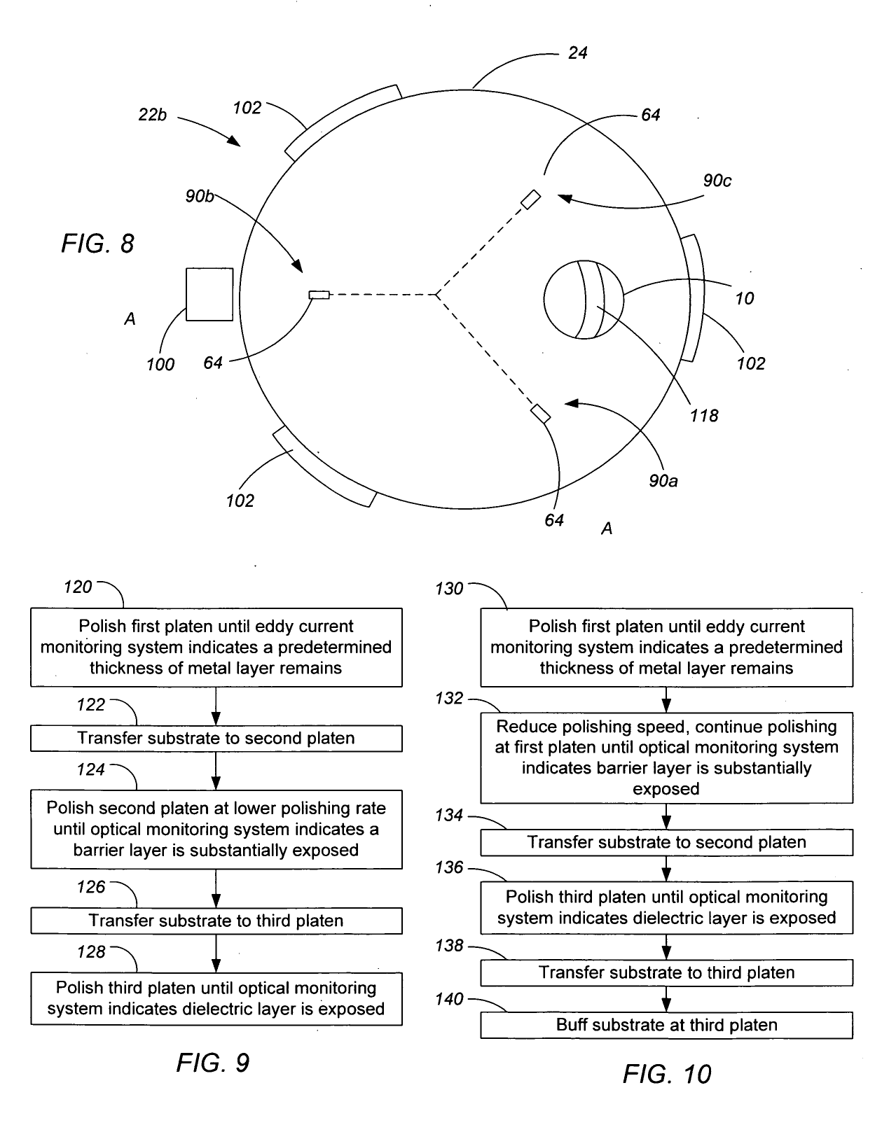

As discussed above, one problem in ECMP is the detection of the endpoint. The polishing system 20 can include an endpoint detection system at one or more of the polishing stations. Referring to FIGS. 4 and 7, in one implementation, at least one of the polishing stations include multiple sensors, e.g., three or more sensors, embedded in or sewed to the platen 24 to monitor the substrate and generate a signal that can be monitored to detect the polishing endpoint. For example, at least one of the polishing stations, e.g., the first polishing station 22a, can include an in-situ eddy current monitoring system with three eddy-current sensors 80a, 80b, 80c (see FIGS. 2 and 4), whereas another polishing station, e.g., the second polishing station 22b, includes an optical monitoring system with three optical sensors 90a, 90b, 90c (see FIGS. 5 and 7). In one implementation, the eddy current and optical sensors, respectively, are placed at the same distance from the axis of rotation of the platen and are separated by equal angular intervals, e.g., 120 degrees if there are three sensors. In another implementation, the sensors (either eddy current or optical) at one or more the polishing stations can be placed at different distances from the axis of rotation of the platen (see FIG. 8). The eddy current monitoring system and optical monitoring system can function as a polishing process control and endpoint detection system. The use of three sensors for each platen increases the rate of data collection and thereby improves the accuracy of endpoint detection at the low platen rotation speeds. There may be more than or fewer than three sensors to each monitoring system.

Referring to FIGS. 2, 3A, and 4, in one implementation, three recesses 50 are formed in the platen 24, and an aperture 52 is formed in the polishing pad 30 overlying each recess 50 (for simplicity, only two recesses are shown in FIG. 2 and only one recess is shown in FIG. 3A). The recesses 50 and apertures 52 are positioned such that they pass beneath the substrate 10 during a portion of the platen's rotation, regardless of the translational position of the carrier head.

At one of the polishing stations, e.g., the first polishing station 22a, a sensor module 54 that houses the eddy current sensor 80a, 80b or 80c fits into each recess 50. The sensor module 54 includes a projection 56 that extends partially into the aperture 52 in the polishing pad 30. The top surface of the projection may be 40-60 mils below the polishing surface 34. The sides of the projection 56 may be sealed to the sides of the recess 50 by an O-ring seal 58 to prevent electrolyte from leaking into the interior of the platen 24.

Each eddy current sensor, e.g., sensor 80a, includes a coil 84 (shown most clearly in FIG. 3A) and a core 86 to generate an oscillating magnetic field that can induce eddy currents in a conductive layer of an adjacent substrate. The coil 84 is connected to drive and sense circuitry, such as a driving oscillator and a capacitor, that can be located on a printed circuit board 88 located in the sensor housing 54. The coil 84 and core 86 can be positioned in or extend into the projection 56 of the sensor housing 54 so as to be positioned in close proximity to the surface of the substrate 10 during polishing. The eddy currents cause the conductive layer to act as an impedance source in parallel with the coil 84. As the thickness of conductive layer changes, the impedance changes, and the sensor 80a can detect this change and output a signal representative of the thickness of the conductive layer. Suitable eddy current monitoring systems are described in U.S. patent application Ser. No. 09/574,008, filed May 19, 2000, and in U.S. patent application Ser. No. 10/633,276, filed Jul. 31, 2003, the entirety of which are incorporated herein by reference.

The signal from each sensor 80a, 80b, 80c is directed to switching circuitry, e.g., a common printed circuit board 114, that combines the signals to generate a common output signal 116 that is directed through a rotary coupling to the computer 110. For example, the signal from each individual sensor can be output while that sensor underlies the substrate 10 (e.g., as detected using the position sensor 100 discussed below). As a result, in each rotation of the platen, the common output signal 116 will include the signal from each sensor 80a, 80b, 80c in sequence. Although illustrated as positioned in the center of the platen, the common board could be integrated into one of the sensors.

Referring to FIGS. 5, 6A and 7, the second polishing station 22b is similar to the first polishing station 22a, with three recesses 60 in the platen 24 (for simplicity, only two recesses are shown in FIG. 5). However, at the second polishing station 22b, each recess includes a sensor module 62 that houses one of the optical sensors 90a, 90b or 90c. In addition, a window is formed in the polishing pad 30′ above each optical sensor 90a, 90b, 90c. For example, an aperture 64 can be formed through the polishing pad 30 (and the counter-electrode 38). A transparent film 66, such as a thin strong polyester film, for example, MYLAR, can cover the entire top surface of the platen 24 and spanning each aperture 64, to prevent the polishing electrolyte from leaking into the platen or the sensor module 62 and damaging the monitoring system.

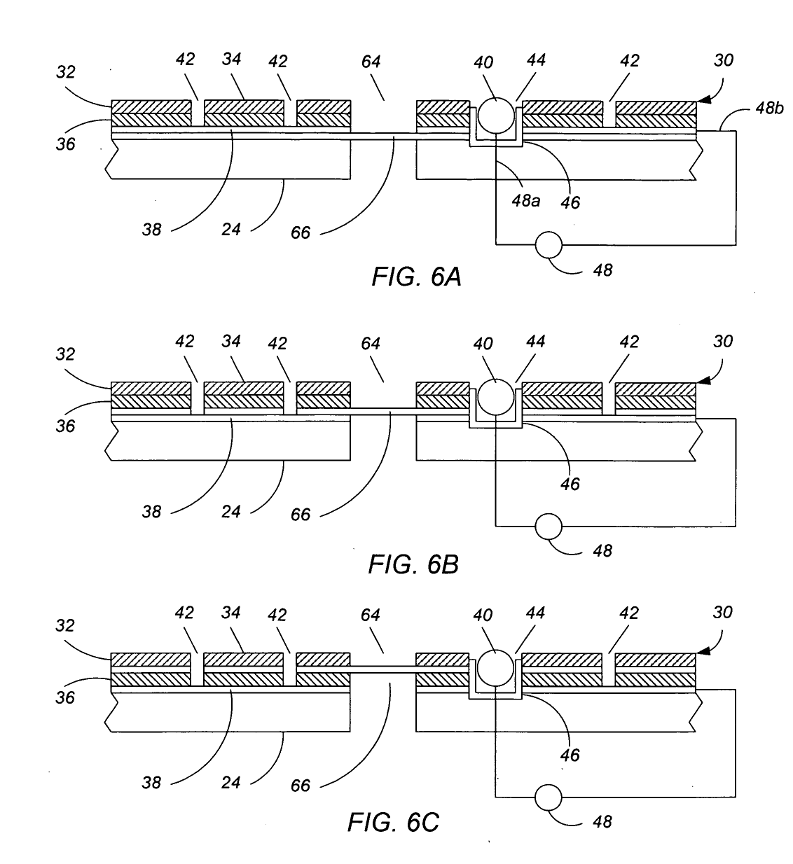

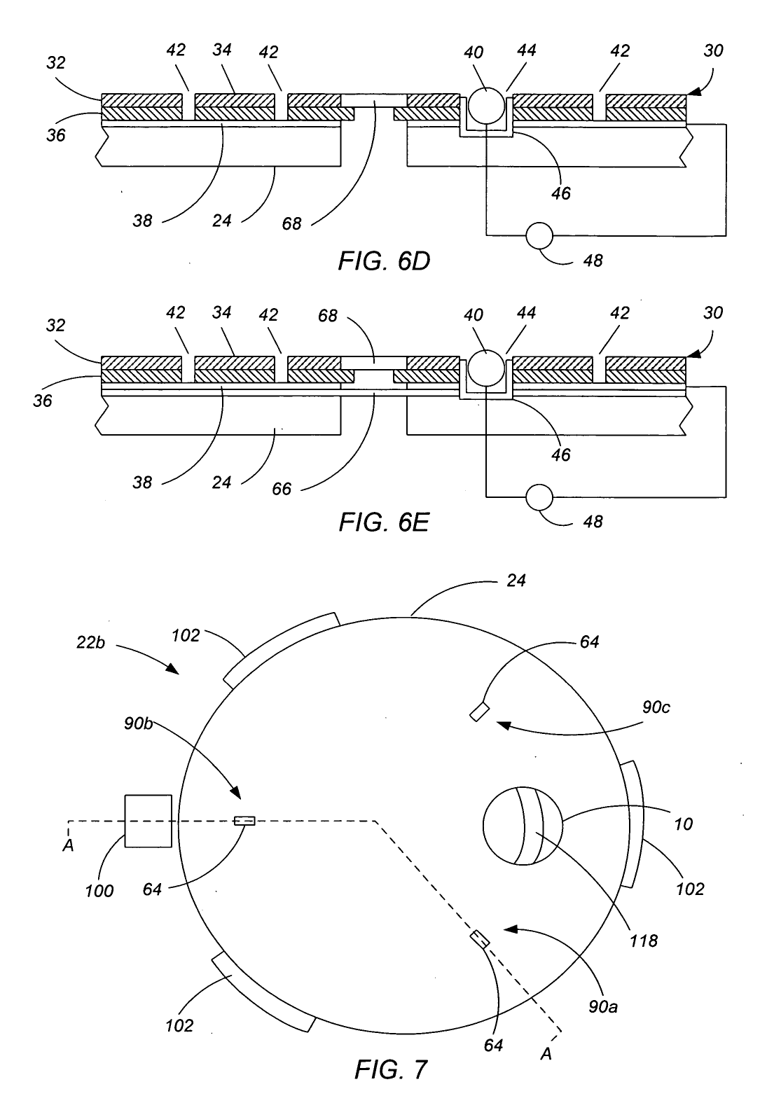

Although FIG. 6A illustrates a window formed by placing a transparent film between the counter-electrode 38 and the platen, many other window implementations are possible. For example, the transparent sheet or film 66 could be part of the polishing pad, e.g., disposed between the counter electrode 38 and the backing layer 36 (as shown in FIG. 6B), or disposed between the backing layer 36 and the polishing layer 32 (as shown in FIG. 6C). In these two cases, apertures would need to be formed through the transparent sheet 66 aligned with the apertures 42 to permit the electrolyte to reach the counter-electrode 38. In addition, the transparent sheet need not cover the entire top surface of the platen; the transparent sheet could be just large enough to span each aperture 64 and seal to the surrounding platen or pad (in this case, there could be a separate sheet for each aperture). Alternatively, a solid transparent window could be formed in the polishing pad 30, in which case the transparent sheet may not be needed. For example, the window could be formed by securing a transparent solid plug 68 in the aperture in the pad 30 (as shown in FIG. 6D). The transparent solid plug could be secured by adhesive or molded to the polishing pad 30. Although FIG. 6D illustrates the plug as positioned in the polishing layer, the plug could extend through the backing layer 36 and the counter-electrode 38. In yet another implementation, the polishing pad can include both a transparent solid plug 68 in an aperture in the pad 30, and a transparent sheet or film 66, e.g., disposed between the counter electrode 38 and the platen, spanning the aperture (as shown in FIG. 6E). In addition, although FIGS. 6A-6E illustrate a system in which the bias is applied by an electrode 40 extending through an aperture 44 in the polishing pad, any of the aforementioned window designs could be incorporated into any of the polishing pad configurations discussed with reference to FIGS. 3A-3C. For example, if the polishing layer is conductive, then a transparent sheet could be positioned between the counter-electrode and the platen, or a transparent plug could be secured in the conductive polishing layer.

Each optical sensor 90a, 90b, 90c, which can function as a reflectometer or interferometer, can be secured to platen 24 in recess 60. The sensors 90a, 90b, 90c of the optical monitoring system can be positioned to measure a portion of the substrate at the same radial distance from the axis of rotation of the second platen as the sensors of the eddy current monitoring system 80 of the first platen. Thus, the optical monitoring system 90 can sweep across the substrate in essentially the same path 118 as the eddy current monitoring system 80.

Each of the three optical sensors 90a, 90b, 90c includes a light source 94 and a detector 96. Each light source generates a light beam 98 which propagates through transparent film 66 and electrolyte 28 to impinge upon the exposed surface of the substrate 10. For example, the light source 94 may be a laser and the light beam 98 may be a collimated laser beam. In general, the optical sensors of the optical monitoring system function as described in U.S. Pat. Nos. 6,159,073, and 6,280,289, the entire disclosures of which are incorporated herein by reference. Each optical sensor 90a, 90b, 90c should be substantially identical, e.g., use detection light of the same wavelength range and same incidence angle. The signal from each sensor 90a, 90b, 90c is directed to switching gravity, 114, which combines the signals into a common output signal 116, which is directed to the computer 110.

In addition, one or more of the polishing stations may include a combined eddy-current and optical sensor, such as described in U.S. patent application Ser. No. 09/847,867, filed May 2, 2001, the entire disclosure of which is incorporated herein by reference. In such a system, the window can be transparent, non-magnetic and non-conductive. Alternatively, the optical and eddy current sensors could be secured to the same platen. For example, the optical and eddy current sensors could be positioned in an alternating sequence around the axis of rotation of the platen, so that they alternately scan the substrate surface. In addition, the optical and eddy current sensors could be positioned on opposite sides of the platen.

Referring to FIGS. 2, 4, 5 and 7, each polishing station of the L-CMP apparatus 20 that includes a monitoring sensor can also include a position sensor 100 to sense when one of the eddy current sensors 80a, 80b, 80c, or one of the optical sensors 90a, 90b, 90c, is beneath the substrate 10. For example, an optical interrupter could be mounted at a fixed point opposite the carrier head 70. Three flags 102 (one flag for each sensor) are attached to the periphery of the platen. The point of attachment and length of flags 102 are selected so that they interrupt the optical signal of the position sensor 100 while the associated sensor 80a, 80b, 80c or 90a, 90b, 90c sweeps beneath the substrate 10. Alternatively, the L-CMP apparatus can include an encoder to determine the angular position of the platen 24.

A general purpose programmable digital computer 110 receives the signals from the eddy current sensing system and the optical monitoring system. Since the monitoring sensors sweep beneath the substrate with each rotation of the platen, information on the metal layer thickness and exposure of the underlying layer is accumulated in-situ and on a continuous real-time basis (once per platen rotation per sensor, e.g., three times per platen rotation if there are three sensors). The computer 110 can be programmed to sample measurements from the monitoring system when the substrate generally overlies a sensor (as determined by the position sensor). As polishing progresses, the reflectivity or thickness of the metal layer changes, and the sampled signals vary with time. The time varying sampled signals may be referred to as traces. The measurements from the monitoring systems can be displayed on an output device during polishing to permit the operator of the device to visually monitor the progress of the polishing operation. In addition, as discussed below, the traces may be used to control the polishing process and determine the end-point of the metal layer polishing operation.

In operation, L-CMP apparatus 20 uses eddy current monitoring system to determine when the bulk of the filler layer has been removed and optical monitoring system to determine when the underlying stop layer has been substantially exposed. The computer 10 applies process control and endpoint detection logic to the sampled signals from each of the three detectors of each polishing station to determine when to change process parameter and to detect the polishing endpoint. Possible process control and endpoint criteria for the detector logic include local minima or maxima, changes in slope, threshold values in amplitude or slope, or combinations thereof.

In addition, the computer 10 can be programmed to divide the measurements from both the eddy current monitoring system and the optical monitoring system from each sweep beneath the substrate into a plurality of sampling zones, to calculate the radial position of each sampling zone, to sort the amplitude measurements into radial ranges, to determine minimum, maximum and average measurements for each sampling zone, and to use multiple radial ranges to determine the polishing endpoint, as discussed in U.S. Pat. No. 6,399,501, the entirety of which is incorporated herein by reference. If the sensors are positioned at different radial positions from the axis of rotation of the platen, as shown in FIG. 8, then the sensors will trace out different paths across the substrate.

Computer 110 may also be connected to the pressure mechanisms that control the pressure applied by the carrier head 70, to the carrier head rotation motor to control the carrier head rotation rate, to the platen rotation motor to control the platen rotation rate, or to polishing electrolyte distribution system to control the slurry composition supplied to the polishing pad. Specifically, after sorting the measurements into radial ranges, information on the metal film thickness can be fed in real-time into a closed-loop controller to periodically or continuously modify the polishing pressure profile applied by a carrier head, as discussed in U.S. patent application Ser. No. 09/609,426, filed Jul. 5, 2000, the entirety of which is incorporated herein by reference. For example, the computer could determine that the endpoint criteria have been satisfied for the outer radial ranges but not for the inner radial ranges. This would indicate that the underlying layer has been exposed in an annular outer area but not in an inner area of the substrate. In this case, the computer could reduce the diameter of the area in which pressure is applied so that pressure is applied only to the inner area of the substrate, thereby reducing dishing and erosion on the outer area of the substrate.

A method of polishing a metal layer, such as a copper layer, is shown in flowchart form in FIG. 9. First, the substrate is polished at the first polishing station 22a to remove the bulk of the metal layer (step 120). The polishing process is monitored by the eddy current monitoring system 40. When the eddy current monitoring system determines that a predetermined thickness, e.g., 300 to 2000 Angstroms, such as 500 to 1000 Angstroms, of the copper layer 14 remains over the underlying barrier layer 16, the polishing process is halted at the first polishing station 22a, and the substrate is transferred to the second polishing station 22b (step 122). Specifically, this first polishing endpoint can be triggered when the signal from the eddy current monitoring system exceeds an experimentally determined threshold value. Exemplary polishing parameters for the first polishing station include a platen rotation rate of two to twenty-five, e.g., five to seven, revolutions per minute (rpm) and a carrier head pressure less than about 1 psi, e.g., about 0.3 psi. As polishing progresses at the first polishing station, the radial thickness information from the eddy current monitoring system can be fed into a closed-loop feedback system to control the pressure and/or the loading area of the carrier head 70 on the substrate. The pressure of the retaining ring on the polishing pad may also be adjusted to adjust the polishing rate. This permits the carrier head to compensate for the non-uniformity in the polishing rate or for non-uniformity in the thickness of the metal layer of the incoming substrate. As a result, after polishing at the first polishing station, most of the metal layer has been removed and the surface of the metal layer remaining on the substrate is substantially planarized.

At the second polishing station 22b, the substrate is polished at a lower polishing rate than at the first polishing station (step 124). For example, the polishing rate is reduced by about a factor of 2 to 20, i.e., by about 50% to 95%, although potentially the polishing rate could be reduced even further. To reduce the polishing rate, the bias voltage on the substrate can be reduced, the carrier head pressure can be reduced, the carrier head rotation rate can be reduced, the composition of the slurry can be changed to introduce a slower polishing slurry, and/or the platen rotation rate could be reduced. For example, the voltage on the substrate may be reduced by about 33% to 50%, and the platen rotation rate and carrier head rotation rate may both be reduced by about 50%.

The polishing process is monitored at the second polishing station 22b by an optical monitoring system. Polishing proceeds at the second polishing station 22b until the metal layer is removed and the underlying barrier layer is exposed. Of course, small portions of the metal layer can remain on the substrate, but the metal layer is substantially entirely removed. The optical monitoring system is useful for determining this endpoint, since it can detect the change in reflectivity as the barrier layer is exposed. Specifically, the endpoint for the second polishing station can be triggered when the amplitude or slope of the optical monitoring signal falls below an experimentally determined threshold value across all the radial ranges monitored by the computer. This indicates that the barrier metal layer has been removed across substantially all of the substrate. Of course, as polishing progresses at the second polishing station 22b, the reflectivity information from the optical monitoring system can be fed into a closed-loop feedback system to control the pressure and/or the loading area of the carrier head 70 on the substrate to prevent the regions of the barrier layer that are exposed earliest from becoming overpolished.

By reducing the polishing rate before the barrier layer is exposed, dishing and erosion effects can be reduced. In addition, the relative reaction time of the polishing machine is improved, enabling the polishing machine to halt polishing and transfer to the third polishing station with less material removed after the final endpoint criterion is detected. Moreover, more intensity measurements can be collected near the expected polishing end time, thereby potentially improving the accuracy of the polishing endpoint calculation. However, by maintaining a high polishing rate throughout most of the polishing operation at the first polishing station, high throughput is achieved. Preferably, at least 75%, e.g., 80-90%, of the bulk polishing of the metal layer is completed before the carrier head pressure is reduced or other polishing parameters are changed.

Once the metal layer has been removed at the second polishing station 22b, the substrate is transferred to the third polishing station 22c (step 126) for removal of the barrier layer. The polishing process can be monitored at the third polishing station 22c by an optical monitoring system, and proceeds until the barrier layer is substantially removed and the underlying dielectric layer is substantially exposed (step 128). The same slurry solution may be used at the first and second polishing stations, whereas another slurry solution may be used at the third polishing station.

An alternative method of polishing a metal layer, such as a copper layer, is shown in flowchart form in FIG. 10. This method is similar to the method shown in FIG. 9 although it requires a polishing station that includes both optical and eddy current sensors. However, both the fast polishing step (step 130) and the slow polishing step (step 132) are performed at the first polishing station 22a. Removal of the barrier layer is performed (step 136) at the second polishing station 22b, and a buffing step is performed at the final polishing station 22c (step 140).

Various aspects of the eddy current and optical monitoring systems can be used in a variety of polishing (including chemical mechanical and electrochemical mechanical) systems. Either the polishing pad, or the carrier head, or both can move to provide relative motion between the polishing surface and the substrate. The polishing pad can be a circular (or some other shape) pad secured to the platen, a tape extending between supply and take-up rollers, or a continuous belt. The polishing pad can be affixed on a platen, incrementally advanced over a platen between polishing operations, or driven continuously over the platen during polishing. The pad can be secured to the platen during polishing, or there could be a fluid bearing between the platen and polishing pad during polishing. The polishing pad can be a standard (e.g., polyurethane with or without fillers) rough pad, a single-layer hard pad, a soft pad, or a fixed-abrasive pad.

Rather than being located on the platen, the weir could surround the entire platen and the platen could be submerged in the polishing electrolyte. In this case, the counter-electrode could be placed under or around the platen rather than between the platen and polishing pad.

The present invention has been described in terms of a preferred embodiment. The invention, however, is not limited to the embodiment depicted and described. Rather, the scope of the invention is defined by the appended claims.

1. A chemical mechanical polishing apparatus, comprising:
a platen to support a polishing pad, the platen rotatable about an axis;
a carrier head to hold a substrate against the polishing pad;
a plurality of substrate monitoring sensors secured to the platen, the sensors spaced at different angular positions about the axis, each of the sensors being substantially identical, and each of the sensors configured to monitor a characteristics of the substrate while that sensor is positioned adjacent the substrate and to generate a signal based thereon; and
a processor to receive the signal from each of the plurality of sensors and determine a polishing endpoint.

2. The apparatus of claim 1, wherein the sensors are spaced at substantially equal radial distances from the axis.

3. The apparatus of claim 1, wherein the sensors are spaced at different radial distances from the axis.

4. The apparatus of claim 1, wherein the sensors are spaced at substantially equal angular intervals around the axis.

5. The apparatus of claim 1, wherein each of the sensors comprises a non-contact sensor.

6. The apparatus of claim 5, wherein each of the sensors comprises an eddy current sensor including a coil to generate an oscillating magnetic field to induce eddy currents in a metal layer in the substrate while the sensor is positioned adjacent the substrate.

7. The apparatus of claim 6, wherein the eddy current sensor includes a core, the coil being wrapped around a portion of the core.

8. The apparatus of claim 5, wherein each of the sensors comprises an optical sensor including a light source to generate a light beam and direct the light beam to impinge the substrate and a detector to receive reflections of the light beam from the substrate while the sensor is positioned adjacent the substrate.

9. The apparatus of claim 8, further comprising a polishing pad on the platen, the polishing pad including a plurality of fluid-impermeable windows, and wherein each sensor directs the light beam through an associated window and each detector receives reflections through the associated window.

10. The apparatus of claim 5, further comprising a housing holding the sensor, the housing positioned at least partially in a cavity in the platen.

11. The apparatus of claim 10, wherein the housing extends above a top surface of the platen.

12. The apparatus of claim 1, further comprising a first electrode to contact a polishing electrolyte on the polishing pad, a second electrode to contact the substrate, and a voltage source to apply a voltage between the first electrode and the second electrode.

13. The apparatus of claim 1, further comprising switching circuitry located in the platen to combine the signal from each of the plurality of sensors and generate a common output signal.

14. The apparatus of claim 1, further comprising a motor to rotate the platen and a controller coupled to the motor, the controller configured to cause the motor to rotate the platen at a rotation rate of about 25 revolutions per minute or less.

15. The apparatus of claim 14, wherein the controller configured to cause the motor to rotate the platen at a rotation rate of about five to seven revolutions per minute.

16. A electrochemical mechanical polishing apparatus, comprising:
a rotatable platen to support a polishing pad;
a weir to contain an electrolyte on the polishing pad;
a carrier head to hold a substrate against the polishing pad;
a first electrical contact for connection to a first electrode for contacting the polishing; electrolyte on the polishing pad;
a second electrical contact for connection to second electrode for contacting the substrate in contact with the polishing pad;
a voltage source to apply a voltage between the first electrical contact and the second electrical contact; and
an eddy current sensor secured to the platen including a coil to generate a magnetic field to induce eddy currents in a metal layer in the substrate while the sensor is positioned adjacent the substrate.

17. The apparatus of claim 16, further comprising a housing holding the eddy current sensor, the housing positioned at least partially in a cavity in the platen.

18. The apparatus of claim 17, wherein the housing extends above a top surface of the platen.

19. The apparatus of claim 18, wherein the housing includes a projection that extends above the top surface of the platen.

20. The apparatus of claim 19, wherein the eddy current sensor includes a core, and at least a portion of the core is positioned in the projection.

21. The apparatus of claim 18, further comprising a polishing pad positioned on the platen, the polishing pad including an aperture aligned with the housing.

22. The apparatus of claim 21, wherein the housing extends partially into the aperture.

23. The apparatus of claim 21, further comprising a fluid seal between the platen and the housing.

24. The apparatus of claim 23, wherein the fluid seal comprises an o-ring.

25. The apparatus of claim 21, wherein the second electrode is provided by a polishing layer in the polishing pad, and the aperture is formed through the second electrode.

26. The apparatus of claim 25, wherein the housing extends at least partially through the aperture in the second electrode.

27. The apparatus of claim 18, further comprising the first electrode and wherein an aperture formed in the first electrode is aligned with the eddy current sensor.

28. The apparatus of claim 27, wherein the housing extends at least partially through the aperture in the first electrode.

29. The apparatus of claim 28, wherein the first electrode is positioned between the platen and a non-conductive polishing layer.

30. The apparatus of claim 16, further comprising a plurality of an eddy current sensors secured to the platen, the sensors spaced at substantially equal radial distances from the axis but at different angular positions about the axis, each of the sensors being substantially identical, each eddy current sensor including a coil to generate a magnetic field to induce eddy currents in a metal layer in the substrate while the sensor is positioned adjacent the substrate.

31. A electro-chemical mechanical polishing apparatus, comprising:
a rotatable platen to support a polishing pad;
a weir to contain an electrolyte on the polishing pad;
a carrier head to hold a substrate against the polishing pad;
a first electrical contact for connection to a first electrode for contacting the polishing electrolyte on the polishing pad;
a second electrical contact for connection to second electrode for contacting the substrate in contact with the polishing pad;
a voltage source to apply a voltage between the first electrical contact and the second electrical contact; and
an optical sensor secured to the platen and including a light source to generate a light beam and to direct the light beam to impinge the substrate and a detector to receive reflections of the light beam from the substrate while the sensor is positioned adjacent the substrate.

32. The apparatus of claim 31, further comprising the polishing pad having a polishing layer with a polishing surface, wherein the polishing pad includes at least one of the first electrode and the second electrode, and wherein the polishing pad includes a window aligned with the optical sensor.

33. The apparatus of claim 32, wherein the window comprises an aperture.

34. The apparatus of claim 33, further comprising a transparent sheet spanning the aperture.

35. The apparatus of claim 34, wherein the transparent sheet spans the polishing pad.

36. The apparatus of claim 34, wherein the polishing pad includes the first electrode as a conductive layer, and a plurality of perforations are formed through the polishing layer to expose the conductive layer.

37. The apparatus of claim 36, wherein the transparent sheet is positioned between the first electrode and the platen.

38. The apparatus of claim 37, wherein the transparent sheet is positioned between the polishing layer and the first electrode, and the perforations are formed through the transparent sheet.

39. The apparatus of claim 34, wherein the polishing layer is conductive and provides the first electrode, and the transparent sheet is positioned between the polishing layer and the platen.

40. The apparatus of claim 31, wherein the window comprises a solid, transparent element secured and extending through at least a portion of the polishing pad.

41. The apparatus of claim 40, wherein the polishing pad includes the first electrode as a conductive layer.

42. The apparatus of claim 41, wherein the first electrode includes an aperture aligned with the solid transparent element.

43. The apparatus of claim 42, wherein the solid transparent element extends at least partially through the first electrode.

44. The apparatus of claim 40, further comprising a transparent sheet is positioned between the polishing layer and the platen.

45. The apparatus of claim 31, further comprising a plurality of optical sensors secured to the platen, the sensors spaced at substantially equal radial distances from the axis but at different angular positions about the axis, each of the sensors being substantially identical, each sensor including a light source to generate a light beam and to direct the light beam to impinge the substrate and a detector to receive reflections of the light beam from the substrate while the sensor is positioned adjacent the substrate.

46. A polishing pad assembly, comprising:
a polishing layer having a polishing surface;
an electrode layer;
a plurality of perforations through the polishing layer to expose the electrode layer; and
a window though the polishing layer and the electrode layer, the window including a fluid-impermeable element.

47. The polishing pad assembly of claim 46, wherein the window includes an aperture through the polishing layer and the electrode layer.

48. The polishing pad assembly of claim 47, wherein the fluid-impermeable element comprises a transparent sheet spanning the aperture.

49. The polishing pad assembly of claim 48, wherein the transparent sheet spans the polishing pad.

50. The polishing pad assembly of claim 48, wherein the transparent sheet is positioned on a side of the electrode layer opposite the polishing layer.

51. The polishing pad assembly of claim 48, wherein the transparent sheet is positioned between the electrode layer and the polishing layer.

52. The polishing pad assembly of claim 51, wherein the perforations extend through the transparent sheet.

53. The polishing pad assembly of claim 51, further comprising a backing layer between the polishing layer and the electrode layer.

54. The polishing pad assembly of claim 53, wherein the transparent sheet is positioned between the electrode layer and the backing layer.

55. The polishing pad assembly of claim 53, wherein the transparent sheet is positioned between the backing layer and the polishing layer.

56. The polishing pad assembly of claim 46, wherein the fluid-impermeable element includes a transparent plug extending through at least a portion of at least one of the polishing layer and the electrode layer.

57. The polishing pad assembly of claim 56, wherein the transparent plug is positioned in the polishing layer.

58. The polishing pad assembly of claim 56, further comprising a non-conductive backing layer between the polishing layer and the electrode layer.

59. The polishing pad assembly of claim 58, wherein the polishing layer is a conductive layer.

60. The polishing pad assembly of claim 56, wherein a top surface of the transparent plug is flush with the polishing surface.

61. A method for electrochemical mechanical polishing of a metal layer on a substrate, comprising:
polishing the substrate at a first polishing station with a first polishing surface immersed in an electrolyte at a first polishing rate;
monitoring polishing at the first polishing station with an eddy current monitoring system;
transferring the substrate to a second polishing station when the eddy current monitoring system indicates that a predetermined thickness of the metal layer remains on the substrate;
polishing the substrate at the second polishing station with a second polishing surface immersed in an electrolyte at a second polishing rate that is lower than the first polishing rate;
monitoring polishing at the second polishing station with an optical monitoring system; and
halting polishing when the optical monitoring system indicates that an underlying layer is at least partially exposed.

62. The method of claim 61, wherein the first underlying layer is a barrier layer.

63. The method of claim 61, wherein polishing at the second polishing station continues until the underlying layer is substantially entirely exposed.

64. The method of claim 61, wherein the eddy current monitoring system includes two or more eddy current sensors.

65. The method of claim 64, wherein the eddy current monitoring system includes three eddy current sensors separated with an angular distance of 120 degrees.

66. The method of claim 64, wherein the eddy current sensors are placed at a same distance from a center of the first polishing station.

67. The method of claim 64, further comprising:
combining output signals from each eddy current sensor in the eddy current monitoring system into a single output signal.

68. The method of claim 61, wherein the optical monitoring system includes two or more optical sensors.

69. The method of claim 68, wherein the optical monitoring system includes three optical sensors separated with an angular distance of 120 degrees.

70. The method of claim 68, wherein the optical sensors are placed at a same distance from a center of the first polishing station.

71. The method of claim 68, further comprising:
combining output signals from each optical sensor in the optical monitoring system into a single output signal.

72. The method of claim 61, further comprising transferring the substrate to a third polishing station and buffing the substrate with a buffing surface.

73. A method of electrochemical mechanical polishing a metal layer on a substrate, comprising:
polishing the substrate at a first polishing rate in an electrolyte while applying a voltage between the substrate and an electrode in the electrolyte;
monitoring polishing with an eddy current monitoring system;
reducing the polishing rate when the eddy current monitoring system indicates that a predetermined thickness of the metal layer remains on the substrate;
monitoring polishing with an optical monitoring system; and
halting polishing when the optical monitoring system indicates that an underlying layer is at least partially exposed.

74. A method of electrochemical mechanical polishing, comprising:
bringing a substrate into contact with a polishing pad on platen rotatable about an axis;
polishing the substrate in an electrolyte while applying a voltage between the substrate and an electrode in the electrolyte;
scanning the substrate sequentially with a plurality of substrate monitoring sensors secured to the platen, the sensors spaced at substantially equal radial distances from the axis but at different angular positions about the axis, each of the sensors being substantially identical, and each of the sensors configured to monitor a characteristic of the substrate while that sensor is positioned adjacent the substrate and to generate a signal based thereon; and
determining a polishing endpoint from signals from the plurality of sensors.
